(19) United States
(12) Patent Application Publication
(10) Pub. No.: US 2026/0054251 A1
(43) Pub. Date: Feb. 26, 2026

(54) BIOCHAR MADE FROM CHLORELLA PYRENOIDOSA MICROALGAE BIOMASS

(71) Applicant: KING FAHD UNIVERSITY OF PETROLEUM AND MINERALS, Dhahran (SA)

(72) Inventors: Shaikh Abdur Razzak, Dhahran (SA); Mohammad Mozahar Hossain, Dhahran (SA); Gus Ali Nur Rohman, Dhahran (SA)

(73) Assignee: KING FAHD UNIVERSITY OF PETROLEUM AND MINERALS, Dhahran (SA)

(21) Appl. No.: 18/815,081

(22) Filed: Aug. 26, 2024

(51) Int. Cl. B01J 20/24; B01J 20/28; B01J 20/30; C02F 1/28; C02F 101/20

(52) U.S. Cl. CPC B01J 20/24; B01J 20/28059; B01J 20/28061; B01J 20/28064; B01J 20/28066; B01J 20/3071; B01J 20/3078; B01J 20/3085; C02F 1/283; C02F 2101/20

(57) ABSTRACT

A biochar made by a process including drying a Chlorella Pyrenoidosa feedstock for 2 to 4 hours to form a powder and mixing the powder with a carbonate salt at a weight ratio of 1:3 to 1:5. The process further includes pyrolyzing the powder and the carbonate salt in an inert atmosphere to a temperature of 500 degrees Celsius (° C.) to 800° C. at a heating rate of 5 degrees Celsius per minute (° C./min) to 15° C./min to form a product, sonicating the product with an acid to form a suspension, decanting the acid, washing and sonicating the product with water, and filtering and drying the product to form the biochar.

### STATEMENT REGARDING PRIOR DISCLOSURE BY THE INVENTORS

Aspects of the present disclosure are described in Razzak, S. A., et al., “High-performance biochar from Chlorella pyrenoidosa algal biomass for heavy metals removal in wastewater” published in Volume 341, Separation and Purification Technology, which is incorporated herein by reference in its entirety.

### STATEMENT OF ACKNOWLEDGEMENT

Support provided by the Interdisciplinary Research Center for Refineries and Advanced Chemicals, King Fahd University of Petroleum and Minerals, Saudi Arabia, through Project INRC2318 is gratefully acknowledged.

### BACKGROUND

### Technical Field

The present disclosure is directed to biochar production and, more particularly, directed to a method of making biochar from a Chlorella pyrenoidosa feedstock and a carbonate salt.

### Description of Related Art

The “background” description provided herein is to generally present the context of the disclosure. Work of the presently named inventors, to the extent it is described in this background section, as well as aspects of the description that may not otherwise qualify as prior art at the time of filing, are neither expressly nor impliedly admitted as prior art against the present invention.

Technology advancement has been detrimental to the environment, for example, industrialization results in increased wastewater production. Discharged wastewater from industrial plants may not be treated properly and may contain hazardous materials, including heavy metals. Heavy metals may build up in the water or the aquatic habitat and harm the environment and human consumption.

Conventional methods of treating wastewater may not handle the heavy metal content in the emitted wastewater discharge from industries. In general, heavy metals found in wastewater are in the dissolved solid form, making it challenging to mechanically filter them out of the water. Utilizing activated carbon is an effective method to absorb heavy metal from water. Activated carbon is often produced using biomass because of the high carbon content in the biomass; Microalgae species and biomass often contains more carbon than other types of biomasses; however, little effort has been exerted to produce activated carbon from microalgae biomass. Activated carbon derived from microalgae has various advantages over other biomass and the cultivation process of activated carbon from microalgae often consumes a lot of the organic and inorganic material in wastewater, and derivative products of the microalgae, such as bio-oil, biogas, and biochar, may be utilized as energy resources. Expansion of microalgae usage may lead to increased mass production of the algae. As a result, production costs may decrease as supply and demand for microalgae rise.

Chlorella pyrenoidosa is one such microalgae that produces activated carbon. Chlorella pyrenoidosa is an advantageous raw material for producing activated carbon due to its high nitrogen and carbon content. By using a thermochemical technique, activated carbon with large surface areas may be created at high temperatures. Additionally, due to the high nitrogen and carbon content of Chlorella pyrenoidosa, activated carbon may be produced in high yields. Large surface areas and high yields of activated carbon are favorable to complexation reactions with heavy metals.

One thermochemical method for making activated carbon from biomass is pyrolysis. The activated carbon from the pyrolysis procedure may have a greater surface area than carbon produced through other thermochemical processes by applying high temperature in an inert atmosphere. Depending on how quickly a sample heats up, the pyrolysis process is separated into two processes: fast and slow. Fast pyrolysis is frequently used because it requires less energy at the same holding temperature than slow pyrolysis. In addition, fast pyrolysis may prevent carbonization side effects, which causes product to clump together at high temperatures and produce smaller pores than slow pyrolysis. Compared to torrefaction, another thermochemical process, the pyrolysis process may result in a larger specific surface area. Pyrolysis uses a higher temperature than torrefaction, creating porous materials with a higher specific surface area.

Biochar may be modified to improve a certain surface area by adding an activating ingredient during carbonization. By including an activating chemical, the carbon chain of the material may continue to react with the activator and produce additional pores, increasing its specific surface area. Carbonate salts are frequently used as an activation agent. Levoglucosan in biomass is inhibited by carbonate salts, such as alkali carbonate, which promotes the generation of CO₂ and H₂ in their gaseous form. Furthermore, molten carbonate salts, particularly carbonate eutectic (lithum, sodium, and potassium carbonates), facilitates bubble ruptures and cavities during the carbonization stage of biomass pyrolysis. The substance in the cavities may become porous, which may enhance specific surface area. Hence, there is a need for improved biochar derived from microalgae as an environmentally friendly and viable alternative to other sources of biochar.

Present methods and sources of producing biochar are inefficient, detrimental to the environment, and expensive. In view of the forgoing, one object of the present disclosure is to provide biochar from microalgae that may circumvent the aforementioned drawbacks of the present publications, such as low yield, poor environmental performance, and unfeasible economic aspects.

### SUMMARY

In an exemplary embodiment, a biochar is described. The biochar is made by a process including drying a Chlorella pyrenoidosa feedstock for 2 to 4 hours (h) to form a powder. The method further includes mixing the powder with a carbonate salt; as such, a weight ratio of the powder to the carbonate salt is from 1:3 to 1:5. Further, the method includes pyrolyzing the powder and the carbonate salt in an inert atmosphere to a temperature of 500° C. to 800° C. at a heating rate of 5° C./min to 15° C./min to form a product; and then sonicating the product with an acid to form a suspension, decanting the acid, washing and sonicating the product with water and filtering and drying the product to form the biochar.

In some embodiments, the method of drying the product to form the biochar includes heating to a temperature of 100° C. to 120° C.

In some embodiments, the carbonate salt is sodium bicarbonate.

In some embodiments, the acid is hydrochloric acid. In some embodiments, the process of making the biochar includes mixing a Chlorella pyrenoidosa feedstock growth solution with a carbonate solution before the drying.

In some embodiments, the biochar has a percent yield of 10 to 30 percent based on an initial amount of the powder.

In some embodiments, the biochar includes a carbon residue having an interplanar spacing (dₕₖₗ) of 35 to 40 angstroms (Å).

In some embodiments, the biochar includes a carbon residue having an average crystallite size of 3 Å to 15 Å.

In some embodiments, the biochar includes a carbon residue having at least one functional group selected from the group consisting of an amine, a nitro, an ester, and an ether.

In some embodiments, the biochar is porous and has a micropore surface area of 35 m²/g to 875 m²/g.

In some embodiments, the biochar has an external surface area of 20 m²/g to 425 m²/g.

In some embodiments, the biochar has a surface area of 50 m²/g to 1300 m²/g.

In some embodiments, the biochar is porous and has an average pore size of 5 nm to 20 nm.

In some embodiments, the biochar is porous and has a total micropore volume of 0.15 cm³/g to 0.5 cm³/g.

In some embodiments, the method of pyrolyzing occurs at a temperature of 750° C. and the biochar is porous and has a micropore surface area of 860 m²/g to 880 m²/g.

In some embodiments, the method of pyrolyzing occurs at a temperature of 750° C. and the biochar has an external surface area of 400 m²/g to 425 m²/g.

In some embodiments, the method of pyrolyzing occurs at a temperature of 750° C. and the biochar has a surface area of 1250 m²/g to 1300 m²/g.

In some embodiments, the method of pyrolyzing occurs at a temperature of 750° C. and the biochar is porous and has an average pore size of 5 nm to 10 nm.

In some embodiments, the method of pyrolyzing occurs at a temperature of 750° C. and the biochar is porous and has a total micropore volume of 0.46 cm³/g to 0.5 cm³/g.

In another exemplary embodiment, a method of filtration is described. The method includes contacting a solution with the above mentioned biochar; as such, the solution includes one or more pollutants. The one or more pollutants are heavy metals. The method further includes collecting a filtrate; as such, the filtrate has a fewer number of pollutants than the solution.

In some embodiments, the one or more pollutants are adsorbed onto the biochar.

The foregoing general description of the illustrative present disclosure and the following detailed description thereof are merely exemplary aspects of the teachings of this disclosure and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1A is a flowchart illustrating a method for producing biochar, according to certain embodiments.

FIG. 1B is a flowchart illustrating a method of filtration, according to certain embodiments.

FIG. 1C is a schematic illustration of a pyrolysis process to produce a modified biochar, according to certain embodiments.

FIG. 2 is a schematic block diagram of an acid treatment process carried out on the modified biochar, according to certain embodiments.

FIG. 3 is a graph showing a yield of modified biochar with an activator and the acid treatment process, according to certain embodiments.

FIG. 4A shows X-ray diffraction (XRD) analysis results for the modified biochar at different temperatures, according to certain embodiments.

FIG. 4B shows average grain size and interplanar spacing of the modified biochar, according to certain embodiments.

FIG. 5A shows Fourier-transform infrared (FTIR) spectroscopy results on an effect of temperature on the modified biochar, according to certain embodiments.

FIG. 5B shows FTIR spectroscopy results of effect of the acid treatment process on the modified biochar, according to certain embodiments.

FIG. 6 shows an effect of the temperature and the acid treatment process on Brunauer-Emmett-Teller (BET) specific surface area of the biochar, according to certain embodiments.

FIG. 7A shows a hysteresis loop of the modified biochar with the activator and acid treatment at a temperature of 550 degrees Celsius (° C.), according to certain embodiments.

FIG. 7B shows a hysteresis loop of the modified biochar with the activator and acid treatment at a temperature of 650° C., according to certain embodiments.

FIG. 7C shows a hysteresis loop of the modified biochar with the activator and acid treatment at a temperature of 750° C., according to certain embodiments.

FIG. 8 shows Barret-Joyner-Halenda (BJH) pore size distribution curves of the modified biochar with the activator and the acid treatment, according to certain embodiments.

### DETAILED DESCRIPTION

In the following description, it is understood that other embodiments may be utilized, and structural and operational changes may be made without departure from the scope of the present embodiments disclosed herein.

When describing the present disclosure, the terms used are to be construed in accordance with the following definitions, unless a context dictates otherwise. Embodiments of the present disclosure will now be described more fully hereinafter with reference to the accompanying drawings wherever applicable, in which some, but not all embodiments of the disclosure are shown. In the drawings, like reference numerals designate identical or corresponding parts throughout the several views. Further, as used herein, the words “a,” “an,” and the like generally carry a meaning of “one or more,” unless stated otherwise. Within the description of this disclosure, where a numerical limit or range is stated, the endpoints are included unless stated otherwise. Also, all values and subranges within a numerical limit or range are specifically included as if explicitly written out.

Furthermore, the terms “approximately,” “approximate,” “about,” and similar terms generally refer to ranges that include the identified value within a margin of 20%, 10%, or preferably 5%, and any values therebetween.

As used herein, “compound” refers to a chemical entity, whether as a solid, liquid, or gas, and whether in a crude mixture or isolated and purified.

As used herein, the term “nanoparticle” refers to a particle wherein the longest diameter is less than or equal to 1000 nanometers.

As used herein, “filtration” refers to the mechanical or physical operation that can be employed for the separation of constituents of homogeneous or heterogeneous solutions and/or mixtures. Types of filtration can be categorized by the estimated sizes of chemicals to be separated and can involve particle filtration (>10 μm), microfiltration (0.1-10 μm), ultrafiltration (0.01-0.1 μm), nanofiltration (NF) (0.001-0.01 μm), reverse osmosis (RO) (<0.001 μm), and the like.

As used herein, the term “biochar” refers to a type of charcoal produced from the thermal decomposition of organic materials, such as agricultural waste, wood chips, plant residues, and the like, under low-oxygen conditions.

As used herein, the term “sonication” refers to the process in which sound waves are used to agitate particles in a solution.

As used herein the term “deionized water” refers to water that has (most of) the ions removed.

As used herein, the term “calcination” refers to heating a compound to a high temperature under a restricted supply of ambient oxygen. This may be performed to remove impurities or volatile substances and to incur thermal decomposition.

As used herein, “pollutant” refers to a substance introduced into the environment that has undesired and/or detrimental consequences to that environment.

As used herein, “functional group” indicates specific groups of atoms within a molecular structure that are accountable for the characteristic chemical reactions and chemical properties of that structure. Suitable examples of functional groups include, but are not limited to, hydrocarbons, groups containing halogen, groups containing oxygen (alcohols, acids, ketones, aldehydes), groups containing nitrogen (nitriles, amines, amides), groups containing silicon (silanes), groups containing phosphorus, groups containing sulfur, and all group identifiable by a skilled person in the art.

As used herein, “attach” or “attachment” refers to linking or uniting by a bond, link, force, or tie in order to keep two or more parts together, which encompasses either direct or indirect attachment such that, for example, a first compound is directly bound to a second compound or material, and the embodiments wherein one or more intermediate compound, and in particular molecule, are disposed between the first compound and the second compound or material.

A weight percent (wt. %) of a component, unless specifically stated to the contrary, is based on the total weight of the formulation or composition in which the component is included. For example, if a particular element or component in a composition or article is said to have 5 wt. %, it is understood that this percentage is in relation to a total compositional percentage of 100%.

The present disclosure is intended to include all isotopes of a given compound or formula, unless otherwise noted. The present disclosure is intended to include all hydration states of a given compound or formula, unless otherwise noted or when heating a material.

Aspects of the present disclosure are directed towards producing a modified biochar using Chlorella pyrenoidosa as a microalgae sustainable feedstock and sodium bicarbonate as an activator through fast pyrolysis in an inert atmosphere. The modified biochar produced has a high specific surface area and may be employed in wastewater applications, particularly for heavy metal removal from solutions.

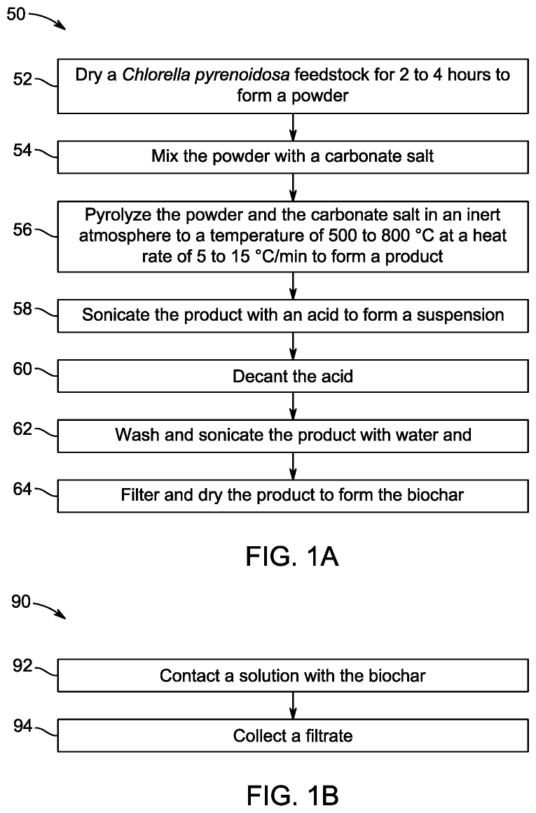

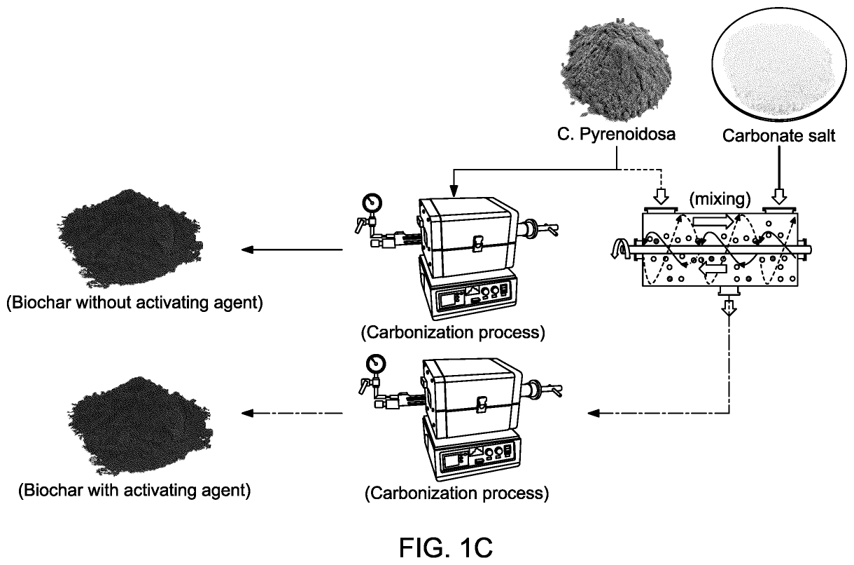

FIG. 1A illustrates a flow chart of a method 50 for producing biochar (also referred to as modified biochar). The order in which the method 50 is described is not intended to be construed as a limitation, and any number of the described method steps may be combined in any order to implement the method 50. Additionally, individual steps may be removed or skipped from the method 50 without departing from the spirit and scope of the present disclosure.

At step 52, method 50 includes drying a Chlorella pyrenoidosa feedstock for 2-4 hours (h), preferably 2.5-3.5 h, and more preferably about 3 h, to form a powder. The drying may be at a temperature of 60 to 100° C., preferably 70 to 90° C., more preferably 75 to 85° C., and yet more preferably at about 80° C. Chlorella pyrenoidosa is a promising potential microalga to produce activated carbon due to its high nitrogen and carbon content. By using a thermochemical technique, activated carbon with a large surface area can be created at high temperatures. Additionally, due to its high nitrogen content and high carbon content, activated carbon can be produced in high yields, both of which are favorable to complexation reactions with heavy metals. The drying can be done by using heating appliances such as hot plates, heating mantles, ovens, microwaves, autoclaves, tapes, oil baths, salt baths, sand baths, air baths, hot-tube furnaces, hot-air guns, and the like.

In a particularly preferred embodiment of the invention, the Chlorella pyrenoidosa feedstock is grown in the presence of a carbonate salt before the drying. In some embodiments, the Chlorella pyrenoidosa feedstock is grown in the presence of a carbonate salt before the drying. Preferably the carbonate salt is introduced into an aqueous composition in which the Chlorella pyrenoidosa feedstock is grown. The carbonate salt solution is preferably added as an aqueous solution to the aqueous growth composition of the Chlorella pyrenoidosa feedstock. The carbonate salt solution is preferably 0.1 to 1 M, more preferably 0.2 to 0.5 M. The aqueous carbonate salt solution is mixed with the Chlorella pyrenoidosa feedstock growth solution in an equal volume amount or less. The resultant dried Chlorella pyrenoidosa feedstock preferably contains the Chlorella pyrenoidosa feedstock powder and the carbonate salt in a weight ratio of 1:0.1 to 1:0.5. Addition of the carbonate salt solution to the Chlorella pyrenoidosa feedstock growth solution provides a Chlorella pyrenoidosa powder that more evenly undergoes pyrolysis and provides a product having greater homogeneity with regard to particle size, pore distribution, pore volume, and/or surface area.

In other embodiments, the Chlorella pyrenoidosa feedstock is grown in the presence of a nitrate salt before the drying. Preferably the nitrate salt is introduced into an aqueous composition in which the Chlorella pyrenoidosa feedstock is grown. The nitrate salt solution is preferably added as an aqueous solution to the aqueous growth composition of the Chlorella pyrenoidosa feedstock. The nitrate salt solution is preferably 0.1 to 1 M, more preferably 0.2 to 0.5 M. The aqueous nitrate salt solution is mixed with the Chlorella pyrenoidosa feedstock growth solution in an equal volume amount or less. In some other embodiments, the Chlorella pyrenoidosa feedstock is grown in the presence of a nitrate salt and a carbonate salt before the drying. Preferably the nitrate salt and the carbonate salt are introduced into an aqueous composition in which the Chlorella pyrenoidosa feedstock is grown. The nitrate and carbonate salt solution is preferably added as an aqueous solution to the aqueous growth composition of the Chlorella pyrenoidosa feedstock. In some embodiments, the nitrate salt and the carbonate salts are added in separate aqueous solutions to the aqueous growth composition of the Chlorella pyrenoidosa feedstock. The nitrate and carbonate salt solution is preferably 0.1 to 1 M, more preferably 0.2 to 0.5 M. The aqueous nitrate and carbonate salt solution is mixed with the Chlorella pyrenoidosa feedstock growth solution in an equal volume amount or less. The resultant dried Chlorella pyrenoidosa feedstock preferably contains the Chlorella pyrenoidosa feedstock powder and the carbonate salt and/or nitrate salt in a weight ratio of 1:0.1 to 1:0.5.

At step 54, the method 50 includes mixing the powder with a carbonate salt. The mixing may be carried out manually or with the help of a stirrer. Suitable examples of carbonate salts include sodium carbonate, sodium bicarbonate, calcium carbonate, potassium carbonate, potassium bicarbonate, and the like. In a preferred embodiment, the carbonate salt is sodium bicarbonate. In some embodiments, the weight ratio of the powder to the carbonate salt is from 1:3-1:5, preferably 1:3.5-1:4.5, and more preferably about 1:4. In a preferred embodiment, the weight ratio of the powder to the carbonate salt is 1:4.

At step 56, the method 50 includes pyrolyzing the powder and the carbonate salt in an inert atmosphere to a temperature of 500-800 degrees Celsius (C), preferably 550-750° C., more preferably 600-700° C., and yet more preferably about 650° C. at a heating rate of 5-15° C./min, preferably 6-14° C./min, preferably 7-13° C./min, preferably 8-12° C./min, more preferably 9-11° C./min, and yet more preferably about 10° C./min to form a product. In some embodiments, once the temperature is reached after the heating rate, the temperature is held constant for 1 to 5 hours, preferably 2 to 4 hours, and more preferably about 3 hours. In some embodiments, the inert atmosphere can be provided by nitrogen, helium, argon, and the like. In a preferred embodiment, the inert atmosphere is provided by nitrogen. In a preferred embodiment, the pyrolysis is done for 3 h at 10° C./min.

At step 58, the method 50 includes sonicating the product with an acid to form a suspension. Acid treatment/treating the product with the acid is performed to remove any unreacted carbonate salts in the product. Suitable examples of acids include hydrochloric acid (HCl), sulphuric acid (H₂SO₄), acetic acid (CH₃COOH), nitric acid (HNO₃), and the like. In a preferred embodiment, the acid is HCl. In some embodiments, the concentration of HCl is 0.05-5 molar (M), preferably 0.1-4.5 M, preferably 0.2-4.0 M, preferably 0.3-3.5 M, preferably 0.4-3.0 M, preferably 0.5-2.5 M, preferably 0.6-2.0 M, preferably 0.7-1.7 M, preferably 0.8-1.5 M, more preferably 0.9-1.2 M, and more preferably about 1.0 M. In a preferred embodiment, HCl has a concentration of 1 M. In some embodiments, other modes of agitation known to those of ordinary skill in the art, for example, via stirring, swirling, mixing, and the like, or a combination thereof, may be employed to form the resultant mixture.

At step 60, method 50 includes decanting the acid. In alternate embodiments, the acids may be separated from the reaction mixture by other methods, such as filtration, evaporation, and the like. When the acid is hydrochloric acid, the acid is preferably removed by sparging with an inert gas such as nitrogen.

At step 62, the method 50 includes washing and sonicating the product with water. The water may be tap water, distilled water, bi-distilled water, deionized water, deionized distilled water, reverse osmosis water, and/or some other water. In a preferred embodiment, the water is deionized water. The sonicating and homogenization are performed ultrasonically for 10 to 120 minutes (min), preferably 15 to 110 min, preferably 30 to 100 min, more preferably 45 to 75 min, and yet more preferably about 60 min. In a preferred embodiment, the sonication is done for 1 h (60 min).

At step 64, the method 50 includes filtering and drying the product to form the biochar. Other suitable techniques for separation include centrifugation, internal and external filtration, natural and forced sedimentation, magnetic separation, vacuum filtration, vacuum distillation, chemical conversion, and any separation techniques known in the art. In a preferred embodiment, the filtration is done using vacuum filtration. The drying can be done by using heating appliances such as hot plates, heating mantles, ovens, microwaves, autoclaves, tapes, oil baths, salt baths, sand baths, air baths, hot-tube furnaces, hot-air guns, and any drying techniques known in the art. The drying of the product to form the biochar includes heating to a temperature of 100-120° C., preferably 101-119° C., preferably 102-118° C., preferably 103-117° C., preferably 104-116° C., preferably 105-115° C., preferably 106-114° C., preferably 107-113° C., preferably 108-112° C., more preferably 109-111° C., and yet more preferably about 110° C. In a preferred embodiment, the drying is done at 110° C.

In some embodiments, the biochar has a percent yield of 10-30 percent (%), preferably 11-29%, preferably 12-28%, preferably 13-27%, preferably 14-26%, preferably 15-25%, preferably 16-24%, preferably 17-23%, preferably 18-22%, preferably 19-21% based on an initial amount of the powder. In a preferred embodiment, when the pyrolysis is carried out at a temperature of 750° C., the biochar has a percent yield of about 13%. In another preferred embodiment, the biochar has a percent yield of about 20% at a pyrolysis temperature of 650° C. In yet another preferred embodiment, the biochar has a percent yield of about 25% at a pyrolysis temperature of 550° C. In some embodiments, the biochar includes a carbon residue having functional groups selected from the group consisting of amines, nitros, esters, and ethers. In some embodiments, the biochar does not include a carbon residue having an alkyl functional group.

In some embodiments, the biochar includes a carbon residue having an interplanar spacing (dₕₖₗ) of 35-40 angstroms (Å), preferably 36-39 Å, and preferably 37-38 Å. In crystallography, interplanar spacing refers to the perpendicular distance between two successive planes in a crystal lattice. These planes are specified by their Miller indices (hkl). In a preferred embodiment, the biochar has a d_{hdl} value of about 37.97 Å at a pyrolysis temperature of 550° C. In another preferred embodiment, the biochar has a percent yield of about 35.92 Å at a pyrolysis temperature of 650° C. In yet another preferred embodiment, when the pyrolysis is carried out at a temperature of 750° C., the biochar has a percent yield of about 36.75 Å.

In some embodiments, the biochar includes a carbon residue having an average crystallite size of 3-15 Å, preferably 4-14 Å, preferably 5-13 Å, preferably 6-12 Å, preferably 7-11 Å, and preferably 8-10 Å. In a preferred embodiment, the biochar has an average crystallite size of about 4.91 Å at a pyrolysis temperature of 550° C. In another preferred embodiment, the biochar has an average crystallite size of about 9.12 Å at a pyrolysis temperature of 650° C. In yet another preferred embodiment, when the pyrolysis is carried out at a temperature of 750° C., the biochar has an average crystallite size of about 11.53 Å.

In some embodiments, the biochar is porous and has an average pore size of 5-20 nanometers (nm), preferably 6-19 nm, preferably 7-18 nm, preferably 8-17 nm, preferably 9-16 nm, preferably 10-15 nm, preferably 11-14 nm, and preferably 12-13 nm. The temperature at which the pyrolysis is carried out/the mode of pyrolysis plays a role in the pore size, total micropore volume, surface area, and the like. In some embodiments, when the pyrolysis is carried out at a temperature of 750° C., the biochar is porous and has an average pore size of 5-10 nm, preferably 6-9 nm, and preferably 7-8 nm. In a preferred embodiment, when the pyrolysis is carried out at a temperature of 750° C., the biochar is porous and has an average pore size of about 19.9 nm. In another preferred embodiment, the biochar has an average pore size of about 11.89 nm at a pyrolysis temperature of 650° C. In yet another preferred embodiment, the biochar has an average pore size of about 7.943 nm at a pyrolysis temperature of 550° C. Pores may be micropores, mesopores, macropores, and/or a combination thereof. In a preferred embodiment, the porous particles have micropores.

In some embodiments, the biochar is porous and has a total micropore volume of 0.15-0.5 cubic centimeters per gram (cm³/g), preferably 0.2-0.45 cm³/g, preferably 0.25-0.4 cm³/g, and preferably 0.3-0.35 cm³/g. In some embodiments, when the pyrolysis is carried out at a temperature of 750° C., the biochar is porous and has a total micropore volume of 0.46-0.5 cm³/g, and preferably 0.47-0.49 cm³/g. In a preferred embodiment, when the pyrolysis is carried out at a temperature of 750° C., the biochar is porous and has a total micropore volume of about 0.486 cm³/g. In a preferred embodiment, the biochar has a total micropore volume of about 0.17 cm³/g at a pyrolysis temperature of 550° C. In another preferred embodiment, the biochar has a total micropore volume of about 0.205 cm³/g at a pyrolysis temperature of 650° C.

In some embodiments, the biochar is porous and has a micropore surface area of 35-875 meters square per gram (m²/g), preferably 85-825 m²/g, preferably 135-775 m²/g, preferably 185-725 m²/g, preferably 235-675 m²/g, preferably 285-625 m²/g, preferably 335-575 m²/g, preferably 385-525 m²/g, and preferably 435-475 m²/g. In some embodiments, when the pyrolysis is carried out at a temperature of 750° C., the biochar is porous and has a micropore surface area of 860-880 m²/g, preferably 861-879 m²/g, preferably 862-878 m²/g, preferably 863-876 m²/g, preferably 865-875 m²/g, preferably 867-874 m²/g, more preferably 869-873 m²/g, and yet more preferably 871-872 m²/g. In a preferred embodiment, when the pyrolysis is carried out at a temperature of 750° C., the biochar is porous and has a micropore surface area of about 871.1 m²/g. In a preferred embodiment, the biochar has a micropore surface area of about 39.44 m²/g at a pyrolysis temperature of 550° C. In another preferred embodiment, the biochar has a micropore surface area of about 260.3 m²/g at a pyrolysis temperature of 650° C.

In some embodiments, the biochar has an external surface area of 20-425 m²/g, preferably 70-375 m²/g, preferably 120-325 m²/g, preferably 170-275 m²/g, and preferably 220-225 m²/g. In some embodiments, when the pyrolysis is carried out at a temperature of 750° C., the biochar has an external surface area of 400-425 m²/g, preferably 401-424 m²/g, preferably 402-423 m²/g, preferably 403-422 m²/g, preferably 404-421 m²/g, preferably 405-420 m²/g, preferably 406-419 m²/g, preferably 407-418 m²/g, preferably 408-417 m²/g, preferably 409-416 m²/g, preferably 410-415 m²/g, more preferably 411-414 m²/g, and yet more preferably 411-412 m²/g. In a preferred embodiment, the biochar is porous and has an external surface area of about 411.14 m²/g at a pyrolysis temperature of 750° C. In another preferred embodiment, the biochar is porous and has an external surface area of about 24.81 m²/g at a pyrolysis temperature of 550° C. In another preferred embodiment, the biochar has an external surface area of about 87.69 m²/g at a pyrolysis temperature of 650° C.

In some embodiments, the biochar has a surface area of 50-1300 m²/g, preferably 150-1200 m²/g, preferably 250-1100 m²/g, preferably 350-1000 m²/g, preferably 450-900 m²/g, preferably 550-800 m²/g, and preferably 650-700 m²/g. In some embodiments, when the pyrolysis is carried out at a temperature of 750° C., the biochar has a surface area of 1200-1300 m²/g, preferably 1250-1300 m²/g, preferably 1260-1295 m²/g, preferably 1270-1290 m²/g, more preferably 1280-1285 m²/g, and yet more preferably 1281-1283 m²/g. In a preferred embodiment, when the pyrolysis is carried out at a temperature of 750° C., the biochar is porous and has a surface area of about 1282.24 m²/g. In another preferred embodiment, the biochar has a surface area of about 64.25 m²/g at a pyrolysis temperature of 550° C. In another preferred embodiment, the biochar has a surface area of about 347.99 m²/g at a pyrolysis temperature of 650° C.

FIG. 1B illustrates a flow chart of a method 90 of filtration. The order in which the method 90 is described is not intended to be construed as a limitation, and any number of the described method steps can be combined in any order to implement the method 90. Additionally, individual steps may be removed or skipped from the method 90 without departing from the spirit and scope of the present disclosure.

At step 92, the method 90 includes contacting a solution with the biochar. The solution includes one or more pollutants. In some embodiments, the one or more pollutants are adsorbed onto the biochar. Suitable examples of pollutants include pharmaceutical pollutants, dyes, pesticides, heavy metals, and the like. In some embodiments, the one or more pollutants are heavy metals. Suitable examples of heavy metals include lead, arsenic, mercury, cadmium, chromium, palladium, platinum, and the like.

At step 94, the method 90 includes collecting a filtrate. The filtrate has a fewer number of pollutants than the solution. Suitable alternate techniques for separation with the biochar and pollutant solution include centrifugation, natural and forced sedimentation, vacuum filtration, vacuum distillation, and any other separation techniques known in the art.

The examples below are intended to further illustrate protocols for preparing, characterizing, and using the biochar and for performing the method described above and are not intended to limit the scope of the claim.

### EXAMPLES

The following examples describe and demonstrate a biochar derived from Chlorella pyrenoidosa as a microalgae sustainable feedstock. The examples are provided solely for illustration and are not to be construed as limitations of the present disclosure, as many variations thereof are possible without departing from the spirit and scope of the present disclosure.

### Example 1: Feedstock

Chlorella pyrenoidosa powder was purchased through Organic Tradition Company, Wilmington, Delaware, USA. Sodium bicarbonate (NaHCO₃) was utilized as an activator, and 1 molar (M) hydrochloric acid (HCl) was employed for acid treatment. To obtain dry powder to be used as feedstock, Chlorella pyrenoidosa powder was dried in an oven at 80 degrees Celsius (° C.) for 3 hours (h).

### Example 2: Modified Biochar Production

Referring to FIG. 1C, a schematic illustration to produce modified biochar is depicted. Dry Chlorella pyrenoidosa powder was mixed in a 1:4 ratio with NaHCO₃ activator. Further, the powder was thoroughly blended to ensure homogeneity. To ensure that temperature is dispersed equally, the prepared sample was placed in the crucible and set in the middle of a one-zone horizontal furnace. To maintain an inert atmosphere during the synthesis process, nitrogen gas is continuously provided. To ensure that the pyrolysis process reaches equilibrium, a fast pyrolysis process was used with a heating rate of 10° C. per minute (° C./min) and a holding time of 3 h. Following the fast pyrolysis process, acid treatment was used to further process the carbon.

### Example 3: Acid Treatment

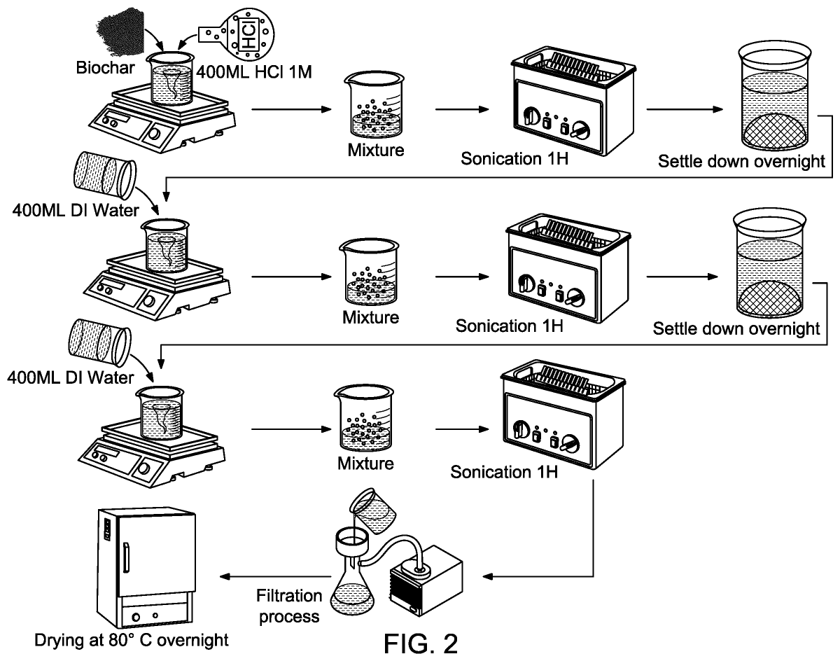

Referring to FIG. 2, a schematic block diagram of an acid treatment process of modified biochar is illustrated, according to certain aspects. In order to clean a surface of the NaHCO₃ combination made from fast pyrolysis and extract the unreacted activator from the NaHCO₃ combination, an acid treatment technique with an acid reagent, 400 mL of 1 M hydrochloric acid, was utilized. To aid in the dispersion process, a solution of modified biochar and acid reagent was placed in an ultrasonic bath for one hour. After the solution was mixed, it was rested overnight to ensure that all suspended carbon has settled, and then a decantation method was used to separate it. Further, the modified biochar was washed in deionized water and placed back in the ultrasonic bath for an additional hour to aid in the dispersion process to ensure that all the acid in the solution is removed and the pH returns to neutral. To ensure that the pH is neutral once more before filtration of the modified biochar in a vacuum, the washing operation was repeated twice. The modified biochar that was solidified was then dried at 110° C. for an entire night to remove any leftover moisture.

### Example 4: Sample Characterization

The carbon (002) peak was examined using X-ray diffraction (XRD), and its average crystallite/grain size and interplanar spacing were calculated. The surface of modified biochar was examined for functional groups using Fourier Transform Infrared (FTIR) spectroscopy. Further, the Brunauer-Emmett-Teller (BET) specific surface area and pore distribution of nitrogen isotherm adsorption and desorption processes were also calculated.

### Example 5: Yield Analysis

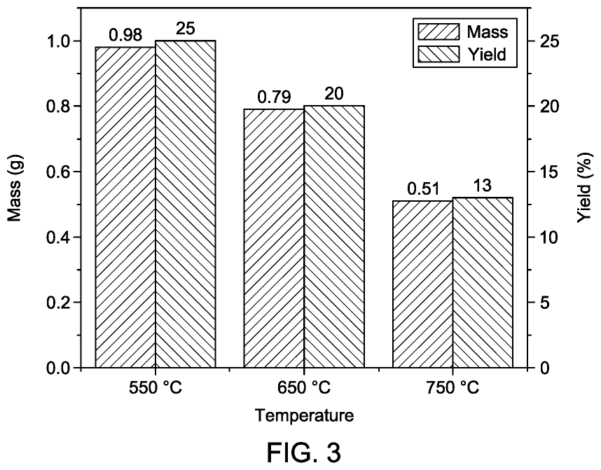

FIG. 3 shows the yield of modified biochar with activator and acid treatment. As can be seen from FIG. 3, the yield decreases as temperatures increase. At higher temperatures, the pyrolysis process leads to more solid decomposition, which results in a lower yield of modified biochar. In addition to increasing production costs and decreasing product yield, greater operating temperatures may also shorten the lifespan and increase maintenance costs of the reactor on an industrial scale. The yield of the biochar ranges from 13% to 25%. Temperature has a impact on thermal degradation, which reduces the yield of the modified biochar. NaHCO₃ promotes consumption of carbon as a reactant to make more carbon dioxide (CO₂) and hydrogen (H₂) gases during the pyrolysis process.

### Example 6: XRD Analysis

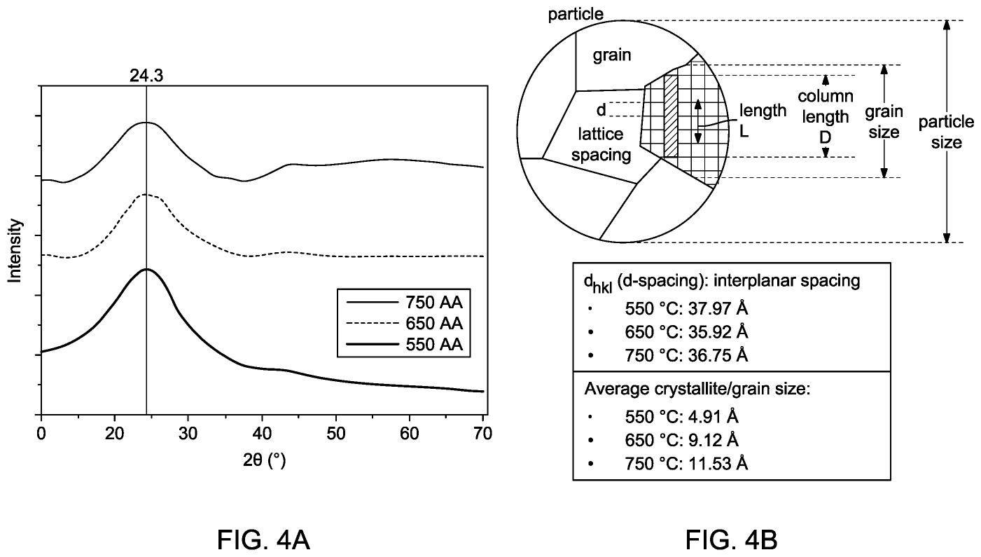

To determine if carbon exists after the pyrolysis process an XRD analysis was performed. In general, carbon has a peak at about 24° in XRD analysis. The modified biochar has a broad peak that formed at 24.3°, as can be seen in FIG. 4A. The formation of carbon in the modified biochar is consistent with the above general theory of XRD results. Further, in general, amorphous carbon is more reactive than crystalline carbon. Based on the interplanar spacing and grain size, amorphous carbon can be divided into soft and hard carbon. Using the findings of the present disclosure and the Scherer equation, interplanar spacing and average grain size may be calculated. The calculation outcome is provided in Table 1. It may be inferred from Table 1, the interplanar spacing of the modified biochar is larger than its typical particle size. This finding suggests that the modified biochar belongs to the category of soft carbon, which is amorphous carbon. FIG. 4A and FIG. 4B show a trend towards a reduction in peak intensity while the pyrolysis temperature is increased. It may suggest that the porosity in the transformed carbon is increasing as the (002) peak intensity decreases.

TABLE 1
Summary of characterization results

| Pyrolysis temperature, ° C. | 550° C. | 650° C. | 750° C. |
|---|---|---|---|
| d-spacing, Å | 37.97 | 35.92 | 36.75 |
| Average grain size, Å | 4.91 | 9.12 | 11.53 |
| S_{Micropore}, m²/g | 39.44 | 260.3 | 871.1 |
| S_{External}, m²/g | 24.81 | 87.69 | 411.14 |
| S_{BET}, m²/g | 64.25 | 347.99 | 1282.24 |
| Average Pore Size, nm | 19.9 | 11.89 | 7.943 |
| Total micropore volume, cm³/g | 0.17 | 0.205 | 0.486 |
| Pore Peak, nm | 78~173 | 81~178 | 2~3.8 |

### Example 7: FTIR Spectrophotometry Analysis

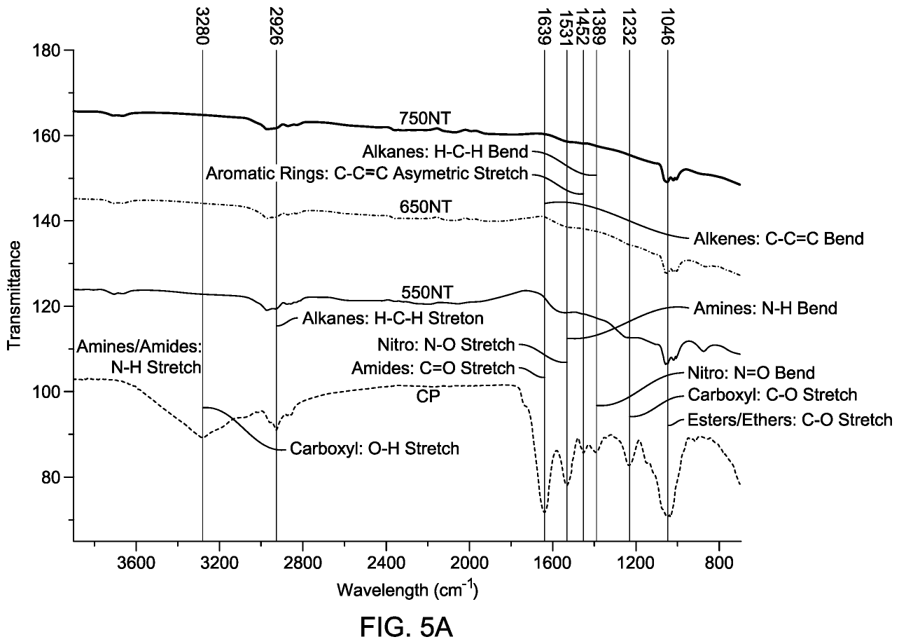

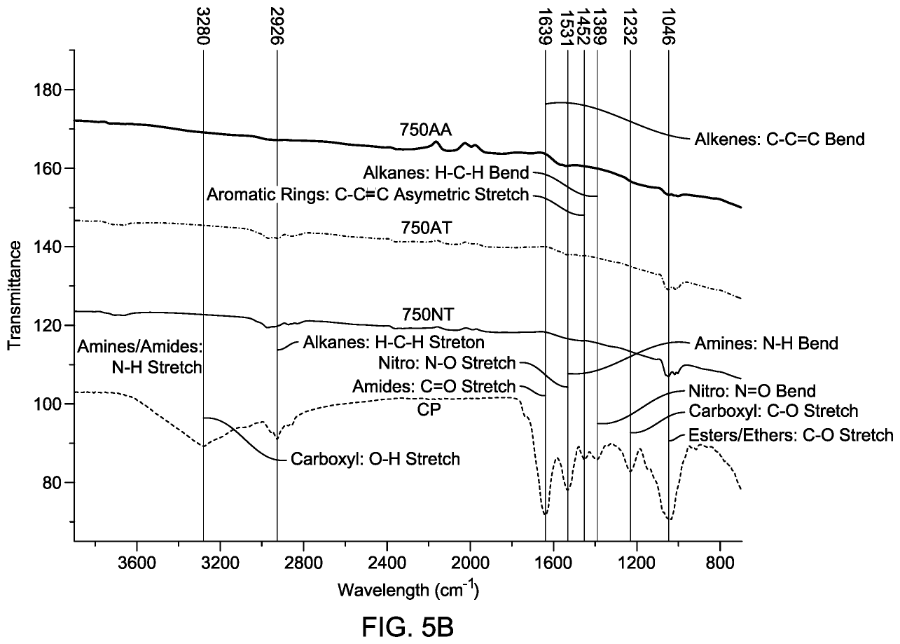

Referring to FIG. 5A and FIG. 5B, graphs depicting FTIR analysis of the biochar are illustrated. Due to various reactions, such as ion exchange and complexation reactions which occur due to the presence of specific functional groups, functional groups may increase the adsorption potential. The present disclosure demonstrates how functional groups are affected by temperature, acid treatment, and a sodium bicarbonate activator. Table 2 lists the functional groups in modified biochar and Chlorella pyrenoidosa. Table 2 indicates that an increase in temperature may cause the destruction of various functional groups. After the pyrolysis process, five functional groups, including alkanes, amines, nitro(s), esters, and ethers, are present out of nine functional groups initially identified by FTIR analysis.

Acid treatment does not alter the presence of functional group compared to pyrolysis alone, but when the NaHCO₃ activating agent is added, only four of the five original functional groups after pyrolysis are left. When NaHCO₃ is used as an activator at 750° C., the alkane functional group is not found. NaHCO₃ encourages the additional reaction of organic chains, which May result in the production of additional gases such as H₂ and CO₂. Further, the functional group of alkanes was consumed during the reaction with NaHCO₃ since it was not visible during FTIR analysis. In general, the process of manufacturing CO₂ and H₂ gases affects the physical structure of the modified biochar by popping bubbles of CO₂ and H₂ gases. This is true even though the reaction with the addition of NaHCO₃ consumes one functional group. By exploding gas mechanisms, the physical structure of the modified biochar may become more porous and crater-like, potentially increasing its specific surface area, further depicted by isotherm adsorption-desorption analysis with the BET Model.

TABLE 2
List of functional groups detected in the FTIR analysis

| Functional Group | CP | 550NT | 650NT | 750NT | 750AT | 750AA |
|---|---|---|---|---|---|---|
| Alkanes | H—C—H Bend | H—C—H | H—C—H | H—C—H | H—C—H | — |
| | | Bend | Bend | Bend | Bend | |
| Amines | N—H Stretch | N—H | N—H | N—H | N—H | N—H |
| | N—H Bend | Bend | Bend | Bend | Bend | Bend |
| Nitros | N═O Bend | N═O | N═O | N═O | N═O | N═O |
| | N═O Stretch | Stretch | Stretch | Stretch | Stretch | Stretch |
| Esters | C—O Stretch | C—O | C—O | C—O | C—O | C—O |
| | | Stretch | Stretch | Stretch | Stretch | Stretch |
| Ethers | C—O Stretch | C—O | C—O | C—O | C—O | C—O |
| | | Stretch | Stretch | Stretch | Stretch | Stretch |
| Amides | C═O Stretch | — | — | — | — | — |
| | N—H Stretch | | | | | |
| Aromatic Rings | C—O═C | — | — | — | — | — |
| | Asymmetric | | | | | |
| | Stretch | | | | | |
| Alkenes | C—C═C Bend | — | — | — | — | — |
| Carboxyl | C—O Stretch | — | — | — | — | — |
| | O—H Stretch | | | | | |

CP = raw Chlorella pyrenoidosa; NT = pyrolysis with no treatment; AT = pyrolysis with acid treatment; AA = activator, pyrolysis, and acid treatment.

### Example 8: Isotherm Adsorption-Desorption Analysis

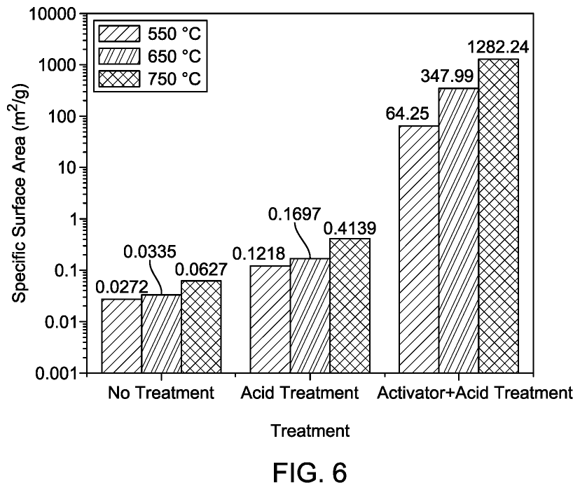

To confirm the specific surface area and pore distribution of the modified biochar, an isotherm adsorption-desorption analysis was performed. The amount of N₂ absorbed and desorbed is plotted as a function of relative pressure (P/P₀). From this plot, the surface area and pore distribution can be inferred. A model for estimating a given surface area is the Brunauer-Emmett-Teller (BET) model and a technique for estimating average pore size and pore dispersion is the Barrett-Joyner-Halenda (BJH) model. FIG. 6 shows the overall outcome of various treatments and temperatures.

FIG. 6 demonstrates that the NaHCO₃ activator increases the specific surface area of the modified biochar. From the BET model, it is also possible to support the original hypothesis from the XRD analysis that raising the temperature may also increase the porosity of the modified biochar, which may increase the specific surface area. Further, raising the temperature also increases the surface area of modified biochar. With activator and acid treatment, the maximum specific surface area of 1282.24 m²/g for the modified biochar is attained at 750° C. The surface area of the modified biochar pyrolyzed at 750° C. comprises 411.14 m²/g of an external surface area and 871.1 m²/g of a micropore surface area.

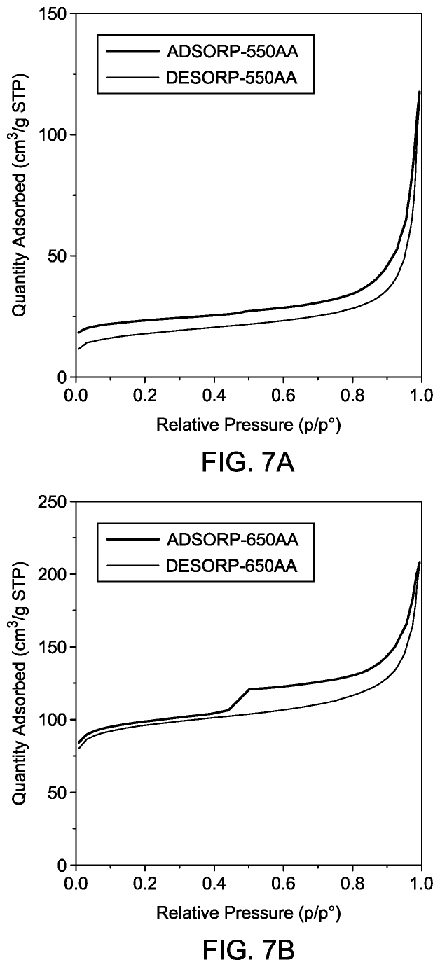

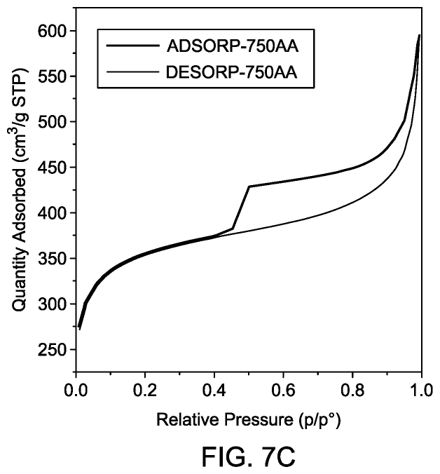

In the BET model, the amount of N₂ that a material adsorbs and desorbs is plotted as a function of relative pressure (P/P₀). FIGS. 7A-7C depict the hysteresis loop shape of the modified biochar for various temperatures with an activator. The shape of the hysteresis loop further revealed the kind of pore structure examined in the modified biochar. The estimated pore shape from the hysteresis loop in FIG. 7C is a slit-shaped or plate-like pore. The adsorption-desorption results of the modified biochar pyrolyzed at 750° C. display the intersection of the adsorb and desorb lines. The results indicate that all N₂ trapped inside the modified biochar may be completely desorbed in the modified biochar pyrolyzed at 750° C. The lines of desorption and adsorption do not meet in the 550° C. and 650° C. modified biochar materials. Due to the small specific surface area of the 550° C. and 650° C. modified biochar, it can be inferred that some N₂ is trapped in the modified biochar. The form of the hysteresis loop was absent at 550° C. The N₂ that is adsorbed in the pores is trapped and the N₂ that is adsorbed on the surface is desorbed immediately after the relative pressure (P/P₀) increases. It is evident that the modified biochar pyrolyzed at 550° C. mimics the properties of non-porous materials. The hysteresis loop form for the modified biochar pyrolyzed at 650° C. is similar to the form the modified biochar pyrolyzed at 750° C.; however, the desorb and adsorb lines do not cross in the modified biochar pyrolyzed at 650° C. The similarity in shape of the hysteresis loop of the modified biochar pyrolyzed at 650° C. and the modified biochar pyrolyzed at 750° C. may be attributed to the relatively large specific surface area of the modified biochar pyrolyzed at 650° C. when compared to the modified biochar pyrolyzed at 550° C.; however, some nitrogen is still trapped in the modified biochar pyrolyzed at 650° C.

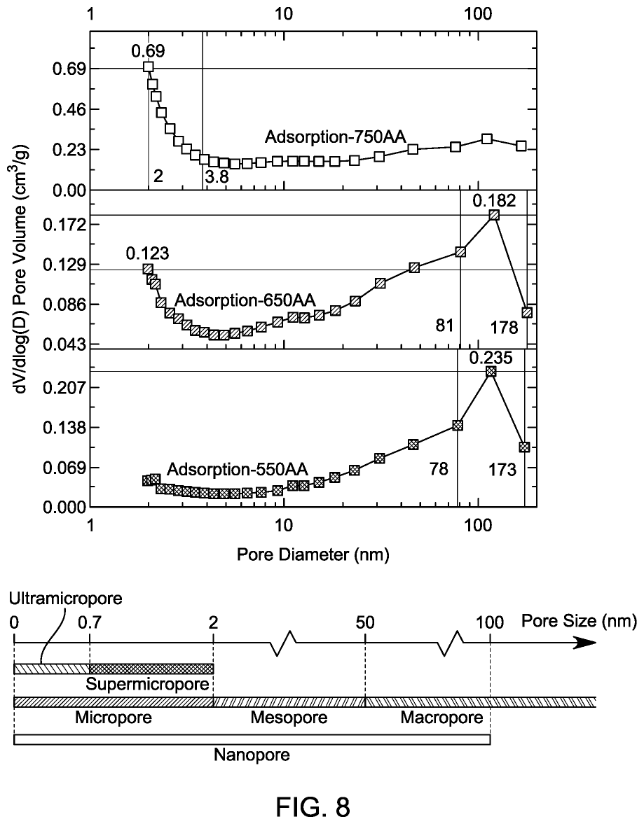

FIG. 8 illustrates an analysis of isotherm adsorption-desorption, which may also be used to infer average pore size and pore distribution. As the temperature rises, it is evident from the graph that the pore size distribution plot is altering. Pore volume for pyrolysis at 550° C. is approximately 0.235 cm³/g and pore sizes range from 78 nanometers (nm) to 173 nm. By raising the pyrolysis temperature to 650° C., there is an increase in pore volume in the 2 nm range (0.123 cm³/g from about 0.060 cm³/g for pyrolysis at 550° C.) and a decrease in the pore volume in the 81 nm to 178 nm range (0.182 cm³/g from 0.235 cm³/g for pyrolysis at 550° C.). When the temperature is raised to 750° C., the pore sizes range from 81 nm to 178 nm nearly completely vanishes, and the majority of pores develop between 2 nm to 3.8 nm with an increase to 0.69 cm³/g in pore volume. The average pore size for each temperature is shown in Table 1. It is seen from the results that the modified biochars may be categorized as mesoporous material based on average pore size.

Aspects of the present disclosure provide a biochar manufactured using Chlorella pyrenoidosa as feedstock. Pyrolysis temperature and use of NaHCO₃ as an activator in synthesizing modified biochar from Chlorella pyrenoidosa also lead to greater porosity and surface area. Using an acid treatment and the NaHCO₃ activator, the highest specific surface area of about 1282.82 m²/g, consisting of about 871.1 m²/g of micropore surface area and about 411.14 m²/g of external surface area, was obtained at a pyrolysis temperature of 750° C. Pore size distribution analysis revealed that as temperature rises, pores get smaller, with an average pore size of 7.943 nm and a total micropore volume of 0.486 cm³/g for the modified biochar at 750° C. with the activator and acid treatment.

From the hysteresis loop shape, the estimated pore shape of modified biochar is a slit-shaped pore or a plate-like pore. According to the XRD analysis, the modified biochar produced is classified under the classification of amorphous soft carbon and mesoporous material. The surface of the modified biochar has a reduced number of functional groups, according to FTIR analysis. Furthermore, the alkane functional group is non-existent at the surface of the modified biochar due to the addition of the NaHCO₃ activator.

Numerous modifications and variations of the present disclosure are possible in light of the above teachings. It is therefore to be understood that within the scope of the appended claims, the disclosure may be practiced otherwise than as specifically described herein.

1. A biochar made by a process including:
drying a Chlorella pyrenoidosa feedstock for 2 to 4 hours (h) to form a powder;
mixing the powder with a carbonate salt,
wherein a weight ratio of the powder to the carbonate salt is from 1:3 to 1:5,
pyrolyzing the powder and the carbonate salt in an inert atmosphere to a temperature of 500 to 800° C. at a heating rate of 5 to 15° C./min to form a product;
sonicating the product with an acid to form a suspension;
decanting the acid;
washing and sonicating the product with water; and
filtering and drying the product to form the biochar.

2. The biochar of claim 1, wherein drying the product to form the biochar includes heating to a temperature of 100 to 120° C.

3. The biochar of claim 1, wherein the carbonate salt is sodium bicarbonate.

4. The biochar of claim 1, wherein the acid is hydrochloric acid, and
wherein the process of making the biochar includes mixing a Chlorella pyrenoidosa feedstock growth solution with a carbonate solution before the drying.

5. The biochar of claim 1, wherein the biochar has a percent yield of 10 to 30 percent based on an initial amount of the powder.

6. The biochar of claim 1, wherein the biochar includes a carbon residue having an interplanar spacing (dₙₖᵢ) of 35 to 40 angstroms (Å).

7. The biochar of claim 1, wherein the biochar includes a carbon residue having an average crystallite size of 3 to 15 Å.

8. The biochar of claim 1, wherein the biochar includes a carbon residue having at least one functional group selected from the group consisting of an amine, a nitro, an ester, and an ether.

9. The biochar of claim 1, wherein the biochar is porous and has a micropore surface area of 35 to 875 m²/g.

10. The biochar of claim 1, wherein the biochar has an external surface area of 20 to 425 m²/g.

11. The biochar of claim 1, wherein the biochar has a surface area of 50 to 1300 m²/g.

12. The biochar of claim 1, wherein the biochar is porous and has an average pore size of 5 to 20 nm.

13. The biochar of claim 1, wherein the biochar is porous and has a total micropore volume of 0.15 to 0.5 cm³/g.

14. The biochar of claim 2, wherein the pyrolyzing occurs at a temperature of 750° C. and the biochar is porous and has a micropore surface area of 860 to 880 m²/g.

15. The biochar of claim 2, wherein the pyrolyzing occurs at a temperature of 750° C. and the biochar has an external surface area of 400 to 425 m²/g.

16. The biochar of claim 2, wherein the pyrolyzing occurs at a temperature of 750° C. and the biochar has a surface area of 1250 to 1300 m²/g.

17. The biochar of claim 2, wherein the pyrolyzing occurs at a temperature of 750° C. and the biochar is porous and has an average pore size of 5 to 10 nm.

18. The biochar of claim 2, wherein the pyrolyzing occurs at a temperature of 750° C. and the biochar is porous and has a total micropore volume of 0.46 to 0.5 cm³/g.

19. A method of filtration, including:
contacting a solution with the biochar of claim 1,
wherein the solution includes one or more pollutants,
wherein the one or more pollutants are heavy metals,
collecting a filtrate,
wherein the filtrate has a fewer number of pollutants than the solution.

20. The method of claim 19, wherein the one or more pollutants are adsorbed onto the biochar.
